(19) United States
(12) Patent Application Publication
(10) Pub. No.: US 2009/0075099 A1
(43) Pub. Date: Mar. 19, 2009

(54) Waterborne Coating Compositions for Optical-use Polyester film

(76) Inventors: Sung-Yueh SHIEH, Taisan Hsiang (TW); Dein-Run Fung, Taisan Hsiang (TW); Ying-Te Huang, Taisan Hsiang (TW); Chao-Hsien Lin, Taisan Hsiang (TW)

Correspondence Address: SINORICA, LLC, 528 FALLSGROVE DRIVE, ROCKVILLE, MD, 20850, US

(21) Appl. No.: 12/326,957

(22) Filed: Dec. 3, 2008

Related U.S. Application Data
(63) Continuation-in-part of application No. 11/649,229, filed on Apr. 9, 2007.

(51) Int. Cl. B32B 27/06; B32B 27/36; C08L 61/28; C08L 33/04; C08K 3/34

(52) U.S. Cl. 428/451; 428/483; 524/512; 524/502; 524/539

(57) ABSTRACT

A water based coating composition containing 2-40 wt % resin, 0.05-30 wt % mixed solution including grafting filler/Si compound/surfactant/polymer and 0.05-10 wt % additives can be used for the production of an optical-use polyester film. The described resin contains about:
a. 20-50 wt %, based on the weight of the coated layer, of composition A which is polyester resin;
b. 10-40 wt %, based on the weight of the coated layer, of composition B which is alkylated melamine formaldehyde crosslinking resin;
c. 20-80 wt %, based on the weight of the coated layer, of composition C which is acrylic resin.

The coated polyester film has some superior properties such as high transparency, low haze value, good adhesion and anti-blocking property. It is suitable for optical applications such as a base film of the brightness enhance film or a base film for the light diffusing plate in a LCD.

### CROSS-REFERENCE TO RELATED APPLICATIONS

This application is a continuation-in-part application of U.S. patent application Ser. No. 11/649,229 filed on Apr. 9, 2007.

### TECHNICAL FIELD

The present invention relates to a coating composition for the polyester base film, and the coated polyester film which shows some superior properties such as high transparency, low haze value, good adhesion and anti-blocking properties, is suitable for optical applications such as light diffusing plate, brightness enhance film, anti-reflection film, and protection film in a LCD (or CRT).

### BACKGROUND ART

In recent years, 3C products are widely used in the daily life, such as notebook computers, LCD TV, etc., thereby promote the market demand of LCD and the related optical materials. Due to high transparency, chemical resistance and dimension stability, the biaxial oriented polyester film is extensively used in various optical film applications; in addition to chemical resistance and dimension stability required by a general polyester film, this optical use polyester film should possesses high transparency, low haze value, good adhesion and anti-blocking properties.

Generally a coating solution is coated on one side or both sides (FIG. 1) of polyester films to improve the properties described above as cited in the previous arts, e.g. EP No. 1,178,075 A1; U.S. Pat. No. 6,733,863 B1; U.S. Pat. No. 6,482,501B2. In EP No. 1,178,075 A1, a polyester film with high transparency, low haze and good adhesion is disclosed, its coating formulation comprises some known constituents including water soluble polyesters, acrylic resins, 0.01˜0.3 μm fine particles and aliphatic amino compounds etc., since these nano- or sub-micron particles have a quite large surface energy, after coating and drying, the nano- or sub-micron particles tend to aggregate into several micron to dozens of micron sized particles to deteriorate transparency, haze and anti-blocking properties of the polyester film, especially the seriously aggregate particles to cause so-called optical defects will be resulted in LCD applications.

U.S. Pat. No. 6,733,863 B1 and U.S. Pat. No. 6,482,501 B2 also mention a polyester film with a low haze value and containing particles smaller than 20 micron, its coating formulation contains some known ingredients, for example, a water soluble copolyester, polyurethanes, and 0.01˜1.0 μm fine particles with anti-blocking functions; similarly, after drying, the coated formulation with relatively large surface energy nano/sub-micron fine particles is very facile to aggregate to micron size particles, thereby affects optical properties of polyester films.

Besides, U.S. Pat. No. 6,482,501 B2 emphasizes the filtration of coating solutions to remove particles with the size over 20 μm, apparently if the coating solution has the phenomenon of seriously aggregate particles, the quality of polyester films will be seriously influenced; in addition, the said patent also highlights quite good thermo-shrinking dimensional stabilities, but the composition contains a certain degree (10˜90%) of a polyurethane component, its UV light resistance or heat resistance is worse than commonly known polyester or acrylic resin components; facing the critical requirements of LCD, its performance of color tinge, chromatism, etc. is not a suitable choice.

Generally speaking, the transparency, haze and anti-blocking properties of polyester films depend on the crystallinity of the polyester base resin (polyethylene terephthalate, or abbreviated as PET, see FIG. 1-1a) and the type and content of the added micron grade anti-blocking agents (see FIG. 1-1b), and another important factor to be the coated layer on the polyester film. In addition to resins (see FIG. 1-2a), generally fine particles (see FIG. 1-2a) are incorporated to improve the anti-blocking property of polyester films, at the same time, refractive index, surface evenness, etc. of the coated layer are closely linked to the transparency of polyester films, and if the fine particles of the coated layer (see FIG. 1-2b) aggregate, voids will be resulted at its circumference after the stretching of the coated layer; all of these aggregation, void and unevenness deteriorate the transparency, haze and anti-blocking properties of polyester films.

Besides, as concerning the coating layer adhesion of a PET film, the coated layer (FIG. 2-2) should show a superior adhesion to both the polyester base film (FIG. 2-1) and the optical grade acrylic coating layer (FIG. 2-3) for LCD to meet the requirement of adhesion.

Generally, if the polyester surface coating layer material is a pure acrylic resin, it will exhibit a good adhesion to the acrylic coating layer for LCD but has a poor adhesion to PET base film; on the contrary, if the polyester surface coating layer material is a pure polyester resin, it will show a bad adhesion to the acrylic coating layer for LCD, but has a quite good adhesion to PET base film. If polyester resin and acrylic resin can be combined, then the adhesions to both the base film and the LCD coating layer can be improved simultaneously.

### DISCLOSURE OF THE INVENTION

### Problems to be Solved

In view of these troubles, the main purpose of the present invention is to provide a coating solution composition with good adhesion and good filler dispersion properties, which is coated on an ordinary biaxial oriented polyester film by in-line or off-line coating process, the resulted qualities with high transparency, low haze value, good adhesion and anti-blocking properties meet the requirements of an optical-use polyester film.

### Means to Solve the Problems

The invention relates to a water based coating liquid which includes 2-40 wt % of resins, 0.05-30 wt % of mixed solution including a surface treating agent grafting filler and 0.05-10 wt % of additives, wherein the resin composition comprises:

a. 20-50 wt % of component A: a polyester resin (the percentage is based on the weight of the coating layer, FIG. 1-2);
b. 10-40 wt % of component B: a melamine-formaldehyde resin or modified melamine-formaldehyde resin (the percentage is based on the weight of the coating layer, FIG. 1-2);
c. 20-80 wt % of component C: an acrylic resin, such as polyacrylate or polymethacrylate resin (the percentage is based on the weight of the coating layer, FIG. 1-2).

The polyester as the component A of the present invention is obtained from the esterification reaction or ester-exchanging reaction of acid or ester and alcohol, then a polycondensation reaction follows, there is a ester bond in the backbone or the side chain of the resulted polyester resin, there are also water soluble groups, e.g. —SO₃Na, —SO₃NH₄ etc., in the molecular structure.

The polyester resin can be chosen from water soluble or water dispersible polyester resins. Its acid component can be selected from sulfonic diacids (e.g. sulfonyl isophthalic acid, 5-sulfonyl isophthalic acid, 2-sulfonyl isophthalic acid, 4-sulfonyl isophthalic acid, etc.) or non-sulfonyl carboxylic acids (e.g. aromatic, aliphatic or cyclo-aliphtic diacids, or polyfunctional acids); while its alcohol component can be selected from ethylene glycol, di-ethyleneglycol, polyethyleneglycol, propylene glycol, 1,3-propylene glycol, polypropyleneglycol, 1,4-butane-diol, 1,5-pentane-diol, 1,6-hexane-diol, cyclohexane-1,2-diol, 1,3-cyclohexane-dimethanol, 1,4-cyclohexane-dimethanol, cyclohexane-1,4-diol, etc. The preferable polyester resins used in the present invention are for example:

(1) those which contains 42 wt % of terephthalic acid, 8 wt % of isophthalic acid, 3 wt % of 5-sulfonyl isophthalic acid, 4 wt % of 1,2-cyclohexanediacid, 30 wt % of ethylene glycol, 13 wt % of 1,4-butanediol; and

(2) those which contains 40 wt % of terephthalic acid, 4 wt % of isophthalic acid, 2 wt % sulfonyl isophthalic acid, 6 wt % of 1,2-cyclohexanediacid, 30 wt % of ethylene glycol, 13 wt % of 1,4-butanediol and 5 wt % of 1,4-cyclohexane-dimethanol. The content of above polyester is preferably 10-60 wt %, and more preferably 20-50 wt %.

The component B of the present invention is a melamine formaldehyde resin or a modified melamine formaldhyde resin, e.g. melamine formaldhyde resin, a hydroxyl modified melamine formaldhyde derivative obtained from the condensation of melamine and formaldehyde, a hydroxymethyl modified melamine formaldhyde compounds obtained from the partial or complete etherification of lower alcohol or the mixture thereof. Melamine can be a condensate by the polymerization of a monomer or a dimers or above or its mixture. Lower alcohols for the etherification can be methanol, ethanol, isopropanol, n-butanol or isobutanol, but it is not limited therein. The content of melamine formaldehyde resin as a major component of the present invention is preferably 5-40 wt %, more preferably 10-30 wt %.

As the so-called component C of the present invention can be produced with the traditional emulsion polymerization, the monomer component is not critical, can be for example methyl acrylate, methyl methacrylate, ethyl acrylate, butyl acrylate, iso-octyl acrylate, hydroxylethyl acrylate, hydroxylethyl methacrylate, acrylamide, methacrylamide, N-hydroxylmethyl acrylamide or N-hydroxylmethyl methacrylamide etc. Among them, the more effective acrylic resin compositions are as follows:

(1) 30-45 wt % of methyl methacrylate, 30-40 wt % of butyl acrylate, 10-20 wt % of iso-octyl acrylate, 1-10 wt % hydroxyethyl methacrylate and 0.5-10 wt % of N-hydroxylmethyl acrylamide:

(2) 30-45 wt % of methyl methacrylate, 15-30 wt % of ethyl acrylate, 15-30 wt % of butyl acrylate, 5-10 wt % of iso-octyl acrylate, 1-10 wt % of hydroxyethyl acrylate and 0.5-10 wt % of N-hydroxymethyl acrylamide; and

(3) A acrylic grafted copolymer of polymer I and polymer II, wherein polymer I is made from 60-80 wt % of methyl methacrylate, 10-20 wt % of iso-octyl acrylate, 1-5 wt % of hydroxyethyl methacrylate, 0.5-5 wt % of N-hydroxymethyl methacrylamide; and polymer II is made from 50-70 wt % of ethyl acrylate, 10-20 wt % of butyl acrylate, 5-10 wt % of iso-octyl acrylate, 1-5 wt % of hydroxyethyl acrylate, 0.5-5 wt % of N-hydroxymethyl acrylamide. The content of above acrylic resin is preferably 20-90 wt %, more preferably 30-80 wt %.

The modified treating agent in the so-called mixed solution of a surface treating agent grafting filler in the present invention is to take advantage of treating agent under high temperature directly grafting on the surface of fillers. Generally, the grafting method is to put the solution of filler particles (such as: silica or aluminum oxide or hydroxyl aluminum of titanium oxide, etc.) into reactor and heat to the reaction temperature, then the surface treating agent added into said reactor. After a period of reaction time, it is able to graft the surface treating agent on the surface of fillers. The temperature of grafting reaction is preferably 40-95° C., most preferably 60-90° C. The grafting treating agent is selected from silicon compounds (e.g. silanes or polysiloxanes), or surfactants (e.g. SINO-JAPAN Chemical Corp.'s anion type surfactants: ammonium salt of tolylsulfate, ammonium salt of polyethyleneglycol nonylphenol ether sulfate, sodium salt of polyethyleneglycol nonylphenol ether sulfate, ammonium salt of polyethyleneglycol octylphenol ether sulfate, sodium salt of condensated polyethyleneglycol polycyclo-nonylphenol ether methacrylate sulfate; or Uniqema's Maxemul 6106, 6112 anion type surfactants; or Pan Asia's polyethyleneglycol nonylphenol ether, polyethyleneglycol alkylethers; SINO-JAPAN Chemical Corp.'s non-ionic surfactants: polyethyleneglycolstearic ether, ethyleneglycol nonylphenol ether, polyethyleneglycol octylphenol ether, polyethyleneglycol decylether, polyethyleneglycol tri-decylether, polyethyleneglycol lauryl ether etc., or polymers (e.g. those containing polyester or polyacrylate component), or the combinations of one, two or all of them.

Filler particles are inorganic particles, such as aluminum oxide, hydroxyl aluminum, silica, titanium oxide, zirconium oxide, calcium carbonate, magnesium carbonate or barium sulfate. The size of filler particle is controlled between 0.005 μm and 5 μm. The dose of silicon containing grafting treating agent is preferably 0.001-0.05 wt %, more preferably 0.001-0.025 wt %. The dose of surfactant containing treating agent is preferably 0.02-1.0 wt %, more preferably 0.05-0.5 wt %. The dose of polymer containing grafting treating agent is preferably 0.01-15 wt %, more preferably 0.1-10 wt %. The dose of filler particle is preferably 0.01-6 wt %, more preferably 0.02-4 wt %.

The so-called additives in the present invention includes leveling agents, catalysts, co-solvents etc., wherein the said leveling agents includes a silicon-containing additive (e.g. BYK301, BYK307, BYK325, BYK331, BYK333, BYK380N, BYK381 etc., of BYK Corp.), or a fluoro-containing additive (e.g. 3 M's FC-4430 and FC-4432, DuPont's Zonyl FSN-10, Japan DaiKing Corp.'s DSX etc.) or a mixture of silicon and fluorine containing additive (e.g. BYK345, BYK346, BYK347, BYK348 etc.); catalysts are inorganic materials, salts, organic materials, alkali materials or acidic materials; co-solvents are solvents like methanol, ethanol, n-propanol, iso-propanol, iso-butanol, butyl cellulose etc. The incorporation of leveling agents can improve the wettability between the coated layer and the base film, and flatness of the coated layer; a catalyst can control the crosslinking reaction rate; while a co-solvent can control the evaporation rate of liquid components.

In addition to the traditional off-line coatings e.g. roll coating, reverse roll coating, gravure roll coating, reverse gravure roll coating, brush coating, wire-wound roll (Meyer rod) coating, spray coating, air knife coating and dipping coating, the methods to coat the coating solution on the polyester film include the so-called the in-line coating; the coated polyester film possesses high transparency, low haze, superior adhesion and anti-blocking properties, thus is suitable for the application of optical use base films (substrates), e.g. diffusion films, light enhancing films of LCD.

The following examples are given to illustrate more concretely, although some preferred examples are revealed and more specifically described, the technology and the scope of the present invention are not limited therein. Besides, the data of the evaluation of physical properties are obtained according to the following methods:

### (1) Determinations of Transparency and Haze:

The transparency and haze of the optical films of the following examples are measured with Haze Meter TC-H III of Tokyo Denshoku Co., according to JIS K7705. The higher the transparency and the lower the haze value, the better the optical properties of the films.

### (2) Determinations of the Dynamic Friction Coefficient:

The dynamic friction coefficients between the coated surface and the coated surface, or between the coated surface and the non-coated surface are determined with Model No. 32-06 of Testing Machines Inc.,/U.S.A, according to ASTM D1894. As for the single-side coated film or the double-side coated film, the dynamic friction coefficients are preferably controlled within the range of 0.25-0.4. The friction coefficient is too high or too low not to be good for the wind-up of optical films.

### (3) Determinations of Particle Size and Dispersion of Anti-Blocking Agents on Coating Layer:

The particle size and the dispersion of anti-blocking agents in the coated surface are determinated with Hitachi S5000 SEM (scanning electronic microscope), at first, the specimens are fixed on the carbon glue, and gold or platinum film plated with a plating machine, then observed at 10,000-time magnification.

### (4) Determination of Adhesion

According to ASTM D3359, the adhesion between the coated surface and acrylic UV glue for the diffusion film or the brightness enhance film is determinated, wherein the coated surface is cured with an exposure instrument (Alexander Jewels Cop.'s Model F300S+AJ-6-UVL). The optical resin for the diffusion film or the brightness enhance film made in Taiwan is coated on the coated surface of the optical film with No. 12 coating bar, after exposuring and drying with an UV exposing machine, it is hundred-sliced with a hundred grid slicing knife, then the obtained hundred grid sliced specimen is laminated firmly with a 3M tape (model 600), and 3M tape is peeled to evaluate the adhesion.

### EXAMPLES

### Example 1

PET pellets blended with aluminum oxide of 2.0 μm average particle size (FIG. 1-1b) are thoroughly dried, then melt extruded in an extruder and cooled on cold rolls with 25° C. surface temperature to become a non-stretched PET sheet, thus the obtained PET sheet is then heated and 4:1 stretched along the machine direction, subsequently single-side coated with a coating solution which is prepared as follows:

a resin mixture with 1.5 wt % of polyester resin, 1.0 wt % of melamine formaldehyde resin and 5.0 wt % of acrylic resin, treating agents containing 0.15 wt % of surfactant A, 0.1 wt % of surfactant B, 0.05 wt % of a silicon compound and 2.2 wt % of a polymer compound, and filler particles to be treated containing 1.2 μm of aluminum oxide particles A and 50 nm of silica particles B are added in 84.65 wt % of water for a surface treatment, finally 0.05 wt % of the catalyst, 5 wt % of isopropanol and 0.2 wt % of butyl cellulose are agitated homogeneously, the resulted coating solution is evenly coated on PET substrate containing 300 ppm of aluminum oxide particles, then the coated mono-axial stretched PET film is clamped fixedly and sent into an 105° C. heating zone for drying to remove moistures in the coated layer, thereby into a 125° C. heating zone for 3.5:1 transverse direction stretching and the obtained biaxial oriented PET film is annealed at 235° C. for 8 seconds to produce a coating type polyester film with a thickness of 50 μm. The tested results of the physical properties are listed in table 1.

### Example 2

The formulation composition comprising PET pellets with silica filler particles of 2.0 μm average particle size (FIG. 1-1b) is dried thoroughly, fed into an extruder, the resulted molten extrudate is cooled on chilling rolls with 25° C. surface temperature and solidified into a non-stretched PET sheet, thus the obtained PET sheet is then heated and 4:1 stretched along the machine direction, thereafter single-side coated with a coating solution which is prepared as follows:

a resin mixture with 1.0 wt % of polyester resin, 0.7 wt % of melamine formaldehyde resin and 4.2 wt % of acrylic resin, treating agents containing 0.30 wt % of surfactant A, 0.2 wt % of surfactant B, 0.05 wt % of
a silicon compound and 5.5 wt % of a polymer compound, and filler particles to be treated including 0.8 μm of silica particle A and 50 nm of silica particle B, are added into 87.34 wt % of water for a surface treatment, finally blended 0.05 wt % of catalysts and 0.5 wt % of butyl cellulose, agitated homogeneously to become a coating solution, then evenly coated on a PET substrate containing 300 ppm of silica particles. Following the steps of Example 1, except the coating formulation composition different from that of Example 1, a double-side coated polyester film with 100 μm thickness is resulted. The tested results of the physical properties are listed in table 1.

### Example 3

The formulation composition comprising PET pellets with 1.5 μm average particle size (FIG. 1-1b) filler particles is dried thoroughly, fed into an extruder, the resulted molten extrudate is cooled on chilling rolls and solidified into a non-stretched PET sheet, thus the obtained PET sheet is then heated and 4:1 stretched along the machine direction, subsequently double-side coated with a coating solution which is prepared as follows:

a resin mixture with 5.25 wt % of polyester resin, 1.5 wt % of melamine resin and 3.0 wt % of acrylic resin, treating agents containing 0.50 wt % of surfactant A, 0.1 wt % of surfactant B and 1.0 wt % of a polymer compound, and filler particles to be treated including 1.5 μm of silica particle A and 50 nm of silica particle B, are added into 78.1 wt % of water to conduct a treatment, finally blended 0.05 wt % of catalysts, 10 wt % of isopropanol and 0.2 wt % of butyl cellulose, agitated homogeneously to become a coating liquid, then evenly coated on a PET substrate containing 300 ppm of silica particles. Following the steps of example 1, except the coating formulation composition different from that of Example 1, a double-side coated polyester film with 100 μm thickness is resulted. The tested results of the physical properties are listed in table 1.

### Example 4

The formulation composition comprising PET pellets with silica of 1.0 μm average particle size (FIG. 1-1b) is thoroughly dried, and melt-extruded with an extruder, chilled and solidified on chilling rolls with the surface temperature of 25° C. to get a non-stretched PET sheet, thus the obtained PET sheet is thereafter heated and 4:1 stretched in the machine direction and double-side coated with a coating solution which is prepared as follows:

a resin mixture with 2 wt % of melamine formaldhyde resin and 9.45 wt % of acrylic resin, treating agents containing 0.3 wt % of surfactant A, 0.1 wt % of surfactant B, 0.002 wt % of silicon compound and 1.0 wt % of polymer compound, and filler particles to be treated comprising 1.5 μm of silica particles A and 70 nm of silica particles B are added into 81.75 wt % of water to conduct a treatment, then 0.05 wt % of catalyst, 5 wt % of isobutanol and 0.2 wt % of butyl cellulose are incorporated therein, homogeneously agitated to become a coating liquid which is evenly coated on a PET substrate containing 600 ppm of silica particles. Following the steps of Example 1 except the coating formulation composition different from that of Example 1, a double-side coated polyester film with a thickness of 100 μm is resulted. The tested results of the physical properties are as table 1.

### Example 5

A PET pellets formulation composition including 300 ppm of silica filler particles of 1.0 μm average particle size (FIG. 1-1b) is thoroughly dried and fed into 3-layer extruders for the melt-extrusion as the first layer (surface layer) and the third layer (surface layer), meanwhile a PET pellet formulation composition without filler particles is thoroughly dried and fed into 3-layer extruders for the melt-extrusion as the second layer (middle layer), chilled on chilling rolls with 25° C. surface temperature and solidified, thus resulted in a non-stretched PET sheet with 1:16:1 of the thickness ratio of these three layers, thus the obtained PET sheet is heated and 4:1 stretched in the machine direction, thereby double-side coated with a coating solution which is made as follows:

a resin mixture with 2 wt % of melamine formaldhyde resin and 9.45 wt % of acrylic resin, treating agents including 0.30 wt % of surfactant A, 0.1 wt % of surfactant B, 0.002 wt % of silicon compound and 1.0 wt % of high polymer and the filler particles to be treated including 1.5 μm silica particles A and 70 nm silica particles B are added into 81.75 wt % of water
to conduct a treatment, then 0.05% of catalyst, 5 wt % of isopropanol and 0.02 wt % of butyl cellulose, agitated homogeneously to get the coating solution which is evenly coated on PET substrate containing 300 ppm of silica particles. Following the steps of Example 1, except different coating formulation composition, a double-side coated polyester film with 100 μm film thickness is made. The physical properties tested are listed in table 1.

### Comparative Example 1

Following the steps and conditions of Example 1 except that no coating is conducted, a non-coated polyester film with 50 μm thickness is obtained. Its physical properties tested are listed in table 1, it shows worse properties.

### Comparative Example 2

A PET pellets formulation composition containing alumina fillers with 2 μm average particle size (FIG. 1-1b) is thoroughly dried, fed into an extruder for the melt-extrusion, chilled and solidified on chilling rolls with 25° C. surface temperature, resulted in a non-stretched PET sheet, thus the obtained PET sheet is heated and 4:1 stretched along the machine direction and single-side coated with a coating solution which is produced as follows:

a resin mixture with 8.25 wt % of polyester resin and 1.5 wt % of melamine formaldehyde resin is added a liquid mixture containing 85.0 wt % of water and 50 nm silica particle B, finally 0.05% of catalyst, 5 wt % of isopropanol and 0.2 wt % of butyl cellulose are incorporated, agitated homogeneously to obtain a coating solution which is coated on PET substrate containing 300 ppm of alumina particles to get a single-side coated polyester film with 50 μm thickness. The tested results of the physical properties are listed in table 1. It shows worse properties.

### Comparative Example 3

A PET pellets formulation composition including silica fillers of 2 μm average particle size (FIG. 1-1b) is thoroughly dried, fed into an extruder for melt-extrusion, chilled and solidified on chilling rolls with 25° C. surface temperature to obtain a non-stretched PET sheet, thus the obtained PET sheet is heated and 4:1 stretched along the machine direction, thereafter single-side coated with a coating solution which is produced as follows:

a resin mixture with 2 wt % of melamine formaldehyde resin and 9.45 wt % of acrylic resin is added a liquid mixture containing 88.0 wt % of water, 2.0 μm silica particles A and 50 nm silica particles B, then 0.05 wt % of catalyst and 0.5 wt % of butyl cellulose are incorporated, agitated homogeneously to obtain a coating solution which is evenly coated on PET substrate containing 300 ppm of silica particles. Following the steps of Example 1 except different film thickness and coating formulation, a single-side coated polyester film with 50 μm thickness is manufactured. The tested results of the physical properties are listed in table 1. It shows worse properties.

### Comparative Example 4

A PET pellets formulation composition containing silica particles with 2 μm average particle size is thoroughly dried, fed into an extruder for melt-extrusion, and chilled and solidified on chilling rolls with 25° C. surface temperature to obtain a non-stretched PET sheet, thus the resulted PET sheet is heated and 4:1 stretched along the machine direction, thereafter single-side coated with a coating solution which is produced as follows:

a resin mixture with 2 wt % of melamine resin and 9.45 wt % of acrylic resin is added a liquid mixture with 88.0 wt % of water and 50 nm silica particles B, finally incorporated 0.05% catalyst and 0.5 wt % of butyl cellulose, and homogeneously agitated to obtain a coating solution which is then evenly coated on PET substrate containing 300 ppm of silica particles. Following the steps of Example 1 except different film thickness and coating formulation, a double-side coated polyester film with 100 μm film thickness is prepared. The tested results of the physical properties are listed in table 1. It shows worse properties.

TABLE 1
Formulations and physical properties comparisons
of the Examples and Comparative Examples

| | | | Example | Example | Example | Example | Example |
|---|---|---|---|---|---|---|---|
| | | | 1 | 2 | 3 | 4 | 5 |
| Substrate | | Material | PET | PET | PET | PET | PET |
| (base film) | | Content of | 300 ppm | 300 ppm | 300 ppm | 600 ppm | 300 ppm |
| | | filler | (2 μm | (2 μm | (1.5 μm | (1 μm | (1 μm |
| | | (Particle | alumina) | silica) | silica) | silica) | silica) |
| | | size/kind) | | | | | |
| Coating | Resin | Polyester | 1.50% | 1.00% | 5.25% | 0% | 0% |
| solution | | resin | | | | | |
| | | Melamine | 1.00% | 0.70% | 1.50% | 2.00% | 2.00% |
| | | resin | | | | | |
| | | Acrylic | 5.00% | 4.20% | 3.00% | 9.45% | 9.45% |
| | | resin | | | | | |
| | Solvent | Water | 84.65% | 87.34% | 78.10% | 81.75% | 81.75% |
| | Treating | Surfactant | 0.15% | 0.30% | 0.50% | 0.30% | 0.30% |
| | agent | A | | | | | |
| | | Surfactant | 0.10% | 0.20% | 0.10% | 0.10% | 0.10% |
| | | B | | | | | |
| | | Silicon | 0.05% | 0.05% | 0% | 0.002% | 0.002% |
| | | compound | | | | | |
| | | polymer | 2.20% | 5.50% | 1.00% | 1.00% | 1.00% |
| | Filler | Content of | 50 ppm | 100 ppm | 50 ppm | 0 ppm | 0 ppm |
| | particles | particle A | (1.2 μm | (0.8 μm | (1.5 μm | (1.5 μm | (1.5 μm |
| | | (Particle/ | alumina) | silica) | silica) | silica) | silica) |
| | | size/kind) | | | | | |
| | | Content of | 1000 ppm | 1500 ppm | 3000 ppm | 1500 ppm | 1500 ppm |
| | | particle B | (50 nm | (50 nm | (50 nm | (70 nm | (70 nm |
| | | (Particle | silica) | alumina) | silica) | silica) | silica) |
| | | size/kind) | | | | | |
| | Additives | Catalyst | 0.05% | 0.05% | 0.05% | 0.05% | 0.05% |
| | | Isopropanol | 5% | 0% | 10% | 5% | 5% |
| | | Butyl | 0.20% | 0.50% | 0.20% | 0.20% | 0.20% |
| | | cellulose | | | | | |
| | | Silicon or | 0.01% | 0.01% | 0.01% | 0.01% | 0.01% |
| | | fluoro | | | | | |
| | | aids | | | | | |

Physical properties comparisons

| | | | | | |
|---|---|---|---|---|---|
| PET film thickness | 50 μm | 100 μm | 100 μm | 100 μm | 100 μm |
| Coating surfaces | single- | double- | double- | double- | double- |
| | side | side | side | side | side |
| Light transparency | 90.20% | 92.20% | 92.80% | 93.00% | 93.10% |
| Haze | 1.00% | 2.38% | 2.00% | 1.90% | 0.80% |
| Adhesion to optical resins | good | good | fair | good | Good |
| Dynamic friction coefficient | 0.398 | 0.309 | 0.311 | 0.289 | 0.281 |
| Filler particles dispersion | good | good | good | good | good |
| in the coated layer | | (FIG. 4) | | | |

| | Comparative | Comparative | Comparative | Comparative |
|---|---|---|---|---|
| Example 5 | Example 1 | Example 2 | Example 3 | Example 4 |
| PET | PET | PET | PET | PET |
| 300 ppm | 300 ppm | 300 ppm | 300 ppm | 300 ppm |
| (1 μm silica) | (2 μm silica) | (2 μm alumina) | (2 μm silica) | (2 μm silica) |
| 0% | | 8.25% | 0% | 0% |
| 2.00% | | 1.50% | 2% | 2% |
| 9.45% | | 0% | 9.45% | 9.45% |
| 81.75% | | 84.90% | 87.85% | 87.85% |
| 0.30% | | 0% | 0% | 0% |
| 0.10% | | 0% | 0% | 0% |
| 0.002% | | 0% | 0% | 0% |
| 1.00% | | 0% | 0% | 0% |
| 0 ppm | | 0 ppm | 50 ppm | 0 ppm |
| (1.5 μm silica) | | (2 μm alumina) | (2 μm silica) | (1 μm silica) |
| 1500 ppm | | 1000 ppm | 1500 ppm | 1500 ppm |
| (70 nm silica) | | (50 nm silica) | (50 nm silica) | (70 nm silica) |
| 0.05% | | 0.05% | 0.05% | 0.05% |
| 5% | | 5% | 0% | 0% |
| 0.20% | | 0.20% | 0.50% | 0.50% |
| 0.01% | | 0% | 0% | 0% |

Physical properties comparisons

| | | | | |
|---|---|---|---|---|
| 100 μm | 50 μm | 50 μm | 50 μm | 100 μm |
| double-side | non-coated | single-side | single-side | double-side |
| 93.10% | 87.50% | 88.30% | 90.40% | 92.20% |
| 0.80% | 1.00% | 1.51% | 1.50% | 2.80% |
| good | bad | bad | acceptable | Acceptable |
| 0.281 | 0.601 | 0.489 | 0.448 | 0.377 |
| good | — | bad | bad | bad (FIG. 3) |

As described above, the present invention provides a water-borne solution composition comprising polyester resin, melamine formaldehyde resin and acrylic resin, a surfactant grafting filler particles and other additives; the coated layer on a substrate formed from the said solution composition shows remarkably improvements on transparency, haze, adhesion and anti-blocking properties, etc.

Although the present invention is explained with preferable embodiments, the technology and the scope of the invention are not just limited therein, but specified in the following Claims.

### BRIEF DESCRIPTION OF THE FIGURES

FIG. 1: The cross-section diagram of a polyester film for the application of LCD optical materials.

FIG. 2: The cross-section diagram of the coated optical material for LCD.

FIG. 3: The filler particle dispersion in the traditional coated layer on a polyester film.

FIG. 4: The filler particle dispersion in the coated layer of the invention on a polyester film.

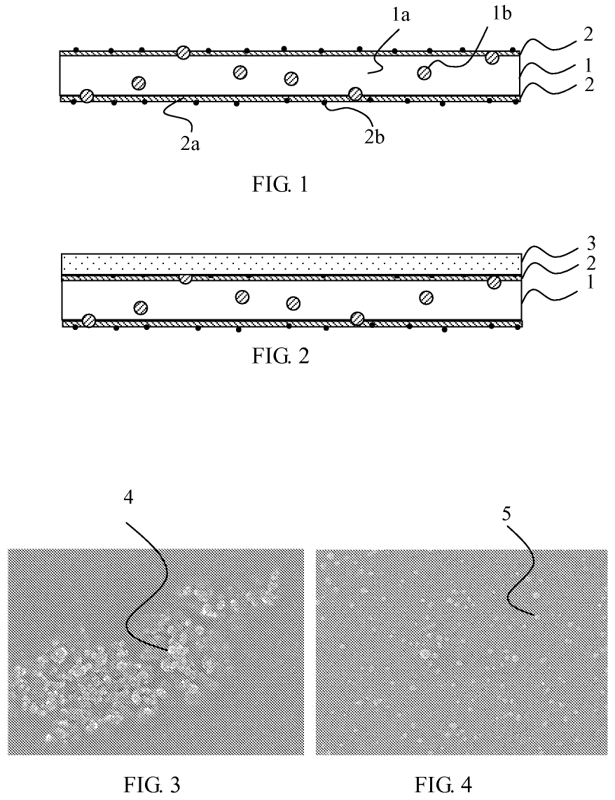

### THE DESCRIPTION OF MAIN ELEMENTS

1. Substrate (base film)

1a: The main components of the substrate

1b: Inorganic particle components added in the substrate

2. The coated layer after drying of the water-borne coating solution

2a: The main components of the coated layer after drying of the water-borne coating solution

2b: Inorganic particle components added in the coated layer

3. The coating layer of an optical resin.
4. Aggregated filler particles in the coated layer on a polyester film
5. Dispersed filler particles in the coated layer on a polyester film

What we claimed is:

1. A polyester film comprising a substrate and a coating layer on at least one side of the substrate, characterized in that the coating solution for the coating layer comprises 2-40 wt % of resins, 0.05-30 wt % of a surface grafting filler particle solution and 0.05-10 wt % of additives.

2. The polyester film as claimed in claim 1, wherein the surface grafting agent is at least one compound selected from silicon compounds, surfactants and polymers, two or all of these compounds.

3. The polyester film as claimed in claim 1, wherein resins used containing two or three components as following:
a. 20-50 wt % of polyester resin;
b. 10-40 wt % of melamine formaldehyde resin or modified melamine
formaldehyde resin;
c. 20-80 wt % of acrylic resin.

4. The polyester film as claimed in claim 1, wherein the substrate is a transparent plastic material of a single- or three-layer structure.

5. The polyester film as claimed in claim 1, wherein the substrate is a biaxial orientated polyethylene terephthalate film.

6. The polyester film as claimed in claim 1, wherein the substrate is biaxial orientated polyethylene 2,6-naphthalate.

7. The polyester film as claimed in claim 1, wherein the filler particle in the coated layer is at least one inorganic compound selected from alumina, aluminum hydroxide, silica, titanium oxide, zirconium oxide, calcium carbonate, magnesium carbonate or barium sulfate.

8. The polyester film as claimed in claim 1, wherein the filler particle content in the coated layer is 0.01%-6%, said percentages are based on the solid content of the coated layer.

9. A polyester film according to claim 1, wherein the coating solution additive for the said coated layer is at least one additive selected among silicon compounds, fluoro compounds or both silicon and fluoro containing compounds.

10. The polyester film as claimed in claim 1, wherein the coated layer on at least one side of said substrate is produced from an off-line coating or an in-line coating process on a biaxial orientated film.

11. The polyester film as claimed in claim 9, wherein the coated layer on at least one side of said substrate is coated with gravure coater, reverse gravure coater, meyer bar coater or die coater.
